(19) United States
(12) Patent Application Publication
(10) Pub. No.: US 2018/0080563 A1
(43) Pub. Date: Mar. 22, 2018

(54) SEALING DEVICE

(71) Applicant: NOK CORPORATION, Tokyo (JP)

(72) Inventors: Yuichi SHUTO, Fukushima-shi (JP); Kei SASAKI, Fukushima-shi (JP); Shohei YAMANE, Fukushima-shi (JP); Yuichi TARUKAWA, Fukushima-shi (JP); Takuya KATO, Fukushima-shi (JP)

(21) Appl. No.: 15/709,826

(22) Filed: Sep. 20, 2017

(30) Foreign Application Priority Data
Sep. 20, 2016 (JP) 2016-182677

(51) Int. Cl. F16J 15/447

(52) U.S. Cl. CPC F16J 15/447; F16C 33/7876

(57) ABSTRACT

A sealing device mounted in a vehicle bearing device, provided with a structure capable of releasing pressure and thus suppressing the internal pressure from increasing, in the event where the internal pressure of the bearing device increases in a sealing device having a seal lip provided toward the inner portion of the bearing device. A protrusion forms a gap between the seal lip and a mating sliding member for adjusting the internal pressure of the bearing device, provided within the range of a sliding portion of the seal lip and on a portion of the circumference of the sliding portion. The protrusion is provided as a protrusion positioned on the tip end portion of the seal lip, a rib-shaped protrusion extending in a shaft direction, and a protrusion with a size that wears out after a predetermined operation time elapses.

### CROSS-REFERENCE TO RELATED APPLICATIONS

This application claims the benefit and priority of Japanese Application No. 2016-182677, filed Sep. 20, 2016. The entire disclosure of the above application is incorporated herein by reference.

### FIELD

The present disclosure relates to a sealing device, and particularly relates to a sealing device mounted in a vehicle bearing device.

### BACKGROUND

As shown in FIG. 4, conventionally, a sealing device (hub bearing seal) 61 is mounted in a vehicle bearing device 51, wherein it is known that the sealing device 61 is provided with a seal lip (main lip) 62 for suppressing foreign matter (not illustrated) such as muddy water of a bearing outer portion A entering a bearing internal portion B, as well as a seal lip (grease lip) 63 for suppressing lubricating grease (not illustrated) of the bearing internal portion B leaking to the bearing outer portion A (please see patent document 1).

The seal lip 63 for sealing grease, of the former, from the object of its installation, is provided with a seal lip tip end portion 63a toward the bearing inner portion B, and furthermore, this seal lip 63 seals grease by slidably contacting across the entire circumference with respect to the outer circumferential surface of a bearing inner ring 53 which is a mating sliding member.

### PRIOR ART DOCUMENTS

Patent Document 1: Unexamined Japanese Patent Application 2010-185491

### SUMMARY

### Problem to be Solved by the Disclosure

However, there is room for improvement in the foregoing conventional art in the following respect.

That is, in the foregoing conventional art, as mentioned above, the seal lip 63 is provided toward the bearing inner portion B, and slidably contacts across the entire circumference with respect to the outer circumferential surface of the bearing inner ring 53. Accordingly, when the internal pressure of the bearing device 51 increases by assembling a blocking cap (not illustrated) on the vehicle body inner side end portion of a bearing outer ring 52 and inner ring 53 during construction of the foregoing bearing device 51, the seal lip 63 is strongly imposed on the outer circumferential surface of the bearing inner ring 53 according to this increasing internal pressure. Therefore, due to this there is concern that the sliding torque of the seal lip 63 will increase, causing adverse effects such as a reduction in fuel consumption of the vehicle.

In light of the foregoing point, the present disclosure is a sealing device mounted in a vehicle bearing device, the object is to provide a sealing device provided with a structure capable of releasing this pressure and thus suppressing the internal pressure from increasing, in the event where the internal pressure of the bearing device increases in a sealing device having a seal lip provided toward the inner portion of the bearing device.

### Means for Solving the Problem

In order to achieve the foregoing object, the sealing device of the present disclosure is a sealing device mounted in a vehicle bearing device, comprising a protrusion for forming a gap of part of the circumference between the seal lip and mating sliding member for adjusting the internal pressure of the bearing device, provided within the range of a sliding portion of the seal lip and on a portion of the circumference of the sliding portion, in a sealing device having a seal lip provided toward the inner portion of the bearing device.

In the sealing device of the present disclosure provided with the foregoing configuration, since the protrusion is provided within the range of the sliding portion of the seal lip and on a portion of the circumference of the sliding portion, a gap of part of the circumference between the seal lip and the mating sliding member is formed in the vicinity of this protrusion, by this protrusion abutting with the outer circumferential surface of the mating sliding member. Accordingly, it is possible to use this gap as an open passage of internal pressure.

At least one portion of the protrusion may be disposed within the range of the sliding portion of the seal lip, however, ordinarily a seal lip is formed wherein that the inner diameter size gradually reduces from the base end portion (root portion) to the tip end portion thereof; therefore, there is concern that if the protrusion is provided in a position recessed too much in a shaft direction from the seal lip tip end portion (position near the base end portion), the seal lip tip end portion will not separate from the outer circumferential surface of the mating sliding member, even if the protrusion abuts with the outer circumferential surface of the mating sliding member, and as a result, a gap will not be formed. Accordingly, it is preferable that the protrusion is disposed as close as possible to the seal lip tip end portion to counter this, then it will be possible to reliably form the gap by providing the protrusion in a position on the seal lip tip end portion.

Furthermore, although the form and size of the protrusion is not particularly limited, there is concern that if the shaft direction length of the protrusion is too small with respect to the shaft direction width of the sliding portion of the seal lip, the gap may be in an early stop position, thus pressure cannot be released. Accordingly, it is preferable that the protrusion is provided as a rib-shaped (shape in which the shaft direction width of the protrusion is greater than the circumferential width of the protrusion) protrusion wherein the protrusion extends in the shaft direction to counter this; according to this, it is then possible to reliably pass through the gap in the shaft direction since the shaft direction width of the sliding portion of the seal lip is not so great. Furthermore, the direction of rotation for the left wheels and right wheels of the vehicle bearing device is opposite; therefore, it is preferable that the protrusion is not a spiral shape having directionality, but forms a rib-shape extending in the shaft direction without directionality, to share the sealing device for bidirectional rotation.

Furthermore, when the internal pressure (high pressure) of the bearing device is released through the foregoing gap, the role of the protrusion comes to an end. Accordingly, if internal pressure does not increase again, the protrusion may be provided as a protrusion with a size that wears out after a predetermined operation time elapses.

### Effect of the Disclosure

The present disclosure is a sealing device mounted in a vehicle bearing device, wherein it is possible to provide a sealing device provided with a structure capable of releasing this pressure and thus suppressing the internal pressure from increasing, in the event where the internal pressure of the bearing device increases in a sealing device having a seal lip provided toward the inner portion of the bearing device. Accordingly, it is extremely effective in suppressing the sliding torque of the seal lip from increasing, and consequently improving the fuel consumption of a vehicle.

### DRAWINGS

FIG. 1 is a cross-sectional view of the essential parts of the sealing device according to the embodiment of the present disclosure.

FIG. 2 is an enlarged cross-sectional view of the essential parts illustrating the mounted state of a grease lip, provided in the same sealing device.

FIG. 3 is an explanatory drawing of the lip sliding portion of a grease lip viewed from radially inward, provided with (A) to (E) respectively in the same sealing device.

FIG. 4 is a cross-sectional view illustrating the mounted state of a sealing device according to a conventional example.

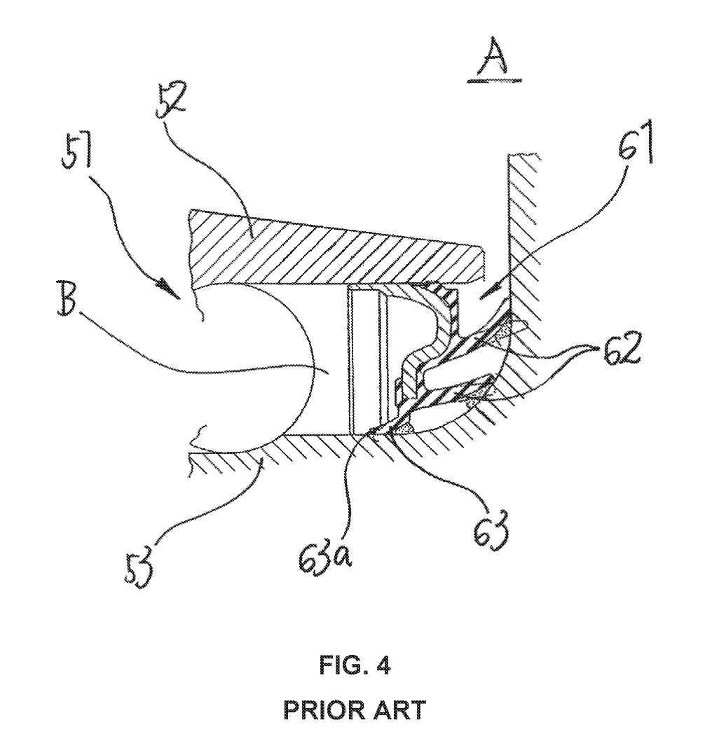

### DETAILED DESCRIPTION

Next, an embodiment of the present disclosure will be described according to the drawings.

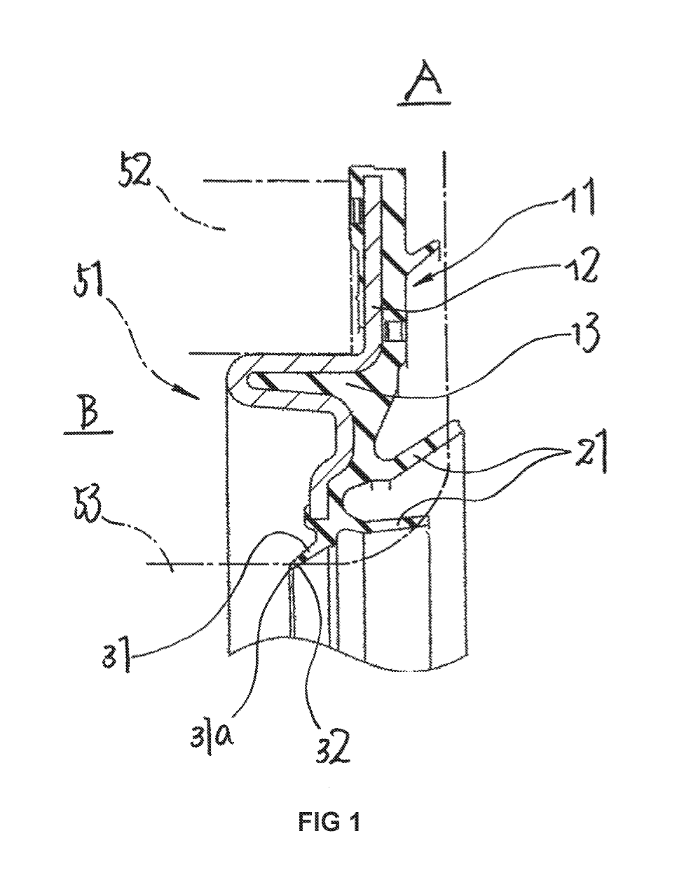

As shown in FIG. 1, the sealing device 11 according to the embodiment is a sealing device (hub bearing seal) mounted in a vehicle bearing device 51, provided with a metal ring 12 fitted to the bearing outer ring 52 as the seal housing, and a rubbery elastic body 13 mounted (crosslink adhesion) on this metal ring 12, wherein, according to the rubbery elastic body 13, the seal lip (main lip) 21 for suppressing foreign matter (not illustrated) such as muddy water of the bearing outer portion A from entering the bearing internal portion B by slidably contacting with the end surface portion of the bearing inner ring 53, which is a mating sliding member, and the seal lip (grease lip, hereinafter also referred to as “grease lip 31”) 31 for suppressing lubricating grease (not illustrated) of the bearing internal portion B from leaking to the bearing outer portion A by slidably contacting with the outer circumferential surface of the bearing inner ring 53, which is a mating sliding member, are integrally provided.

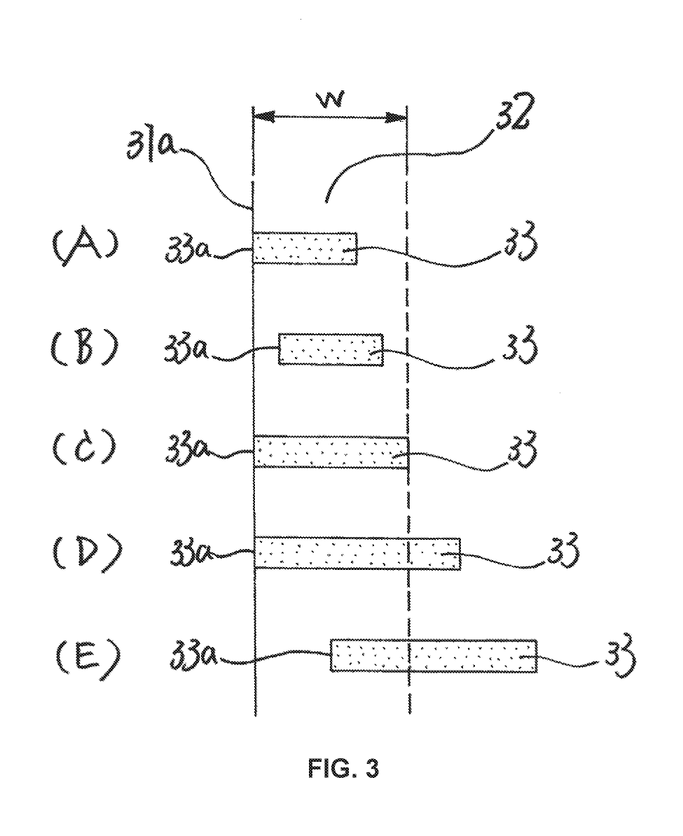

The grease lip 31, from the object of its installation, is provided so that a lip tip end portion 31a faces towards the bearing inner portion B. Furthermore, the grease lip 31 is provided to slidably contact across the entire circumference with respect to the outer circumferential surface of the bearing inner ring 53 which is a mating sliding member. In addition, the grease lip 31 is provided to slidably contact with a predetermined shaft width w (please see FIG. 3) with respect to the outer circumferential surface of the bearing inner ring 53 which is a mating sliding member. Hereinafter, of the inner circumferential surface of this grease lip 31, the position that slidably contacts with respect to the outer circumferential surface of the bearing inner ring 53 which is a mating sliding member is also referred to as a lip sliding portion 32.

In the sealing device 11 of the foregoing configuration, as mentioned above, there may be occasions where the internal pressure of the bearing device 51 increases when a blocking cap (not illustrated) is assembled on the vehicle body inner side end portion of the bearing outer ring 52 and inner ring 53 during construction of the bearing device 51, since the grease lip 31 is provided toward the bearing inner portion B and contacts across the entire circumference with respect to the outer circumferential surface of the bearing inner ring 53. Also, if internal pressure of the bearing device 51 increases in this way, the lip sliding portion 32 of the grease lip 31 is strongly imposed on the outer circumferential surface of the bearing inner ring 53 according to this increasing internal pressure, and sliding torque of the grease lip 31 may increase.

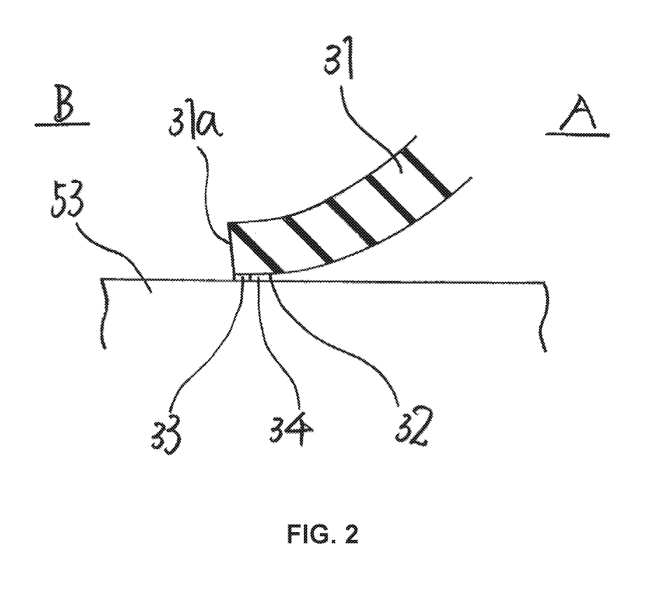

Here, in the sealing device 11 according to the embodiment, as shown enlarged in FIGS. 2 and 3, a protrusion 33 is provided on the inner circumferential surface of the grease lip 31, within the range of the lip sliding portion 32, and on part of the circumference of the lip sliding portion 32, and is configured so that a gap 34 of a part of the circumference is formed between the lip sliding portion 32 and the outer circumferential surface of the bearing inner ring 53, in the vicinity of this protrusion 33, by this protrusion 33 abutting with the outer circumferential surface of the bearing inner ring 53.

Accordingly, since internal pressure can be released by using this gap 34 as an open passage of internal pressure, the lip sliding portion 32 is strongly imposed on the outer circumferential surface of the bearing inner ring 53, and can suppress sliding torque from increasing.

Protrusion 33, as illustrated in FIG. 3(A), (B), or (C), is provided within the range (within the region) of the lip sliding portion 32, provided with a predetermined shaft direction width w (for example, about 0.3 mm), and as illustrated in FIG. 3(D) or (E), provided that one portion thereof is disposed within the range of the lip sliding portion 32, the other portion may jut out from the lip sliding portion 32 to the bearing outer portion A side (on the right-side in the drawing).

Protrusion 33, as illustrated in FIG. 3(A), (C), or (D), is provided with the end portion 33a of the bearing inner portion B side (on the left-side in the drawing) in a position on the lip tip end portion 31a, and as illustrated in FIG. 3(B) or (E), the end portion 33a of the bearing inner portion B side may be provided in a position (position near the base end portion) receded from the lip tip end portion 31a to the shaft direction (bearing outer portion A side).

Protrusion 33 is provided in one location on the circumference of the lip sliding portion 32; however, it may be provided in a plurality of locations on the circumference.

The shape of the protrusion 33 is not particularly limited; for example, it may form a rib-shaped protrusion extending in the shaft direction based on the foregoing reason.

The size of the protrusion 33 is not particularly limited. The shaft direction length of the protrusion 33 may be smaller than the width w of the lip sliding portion 32 (FIG. 3(A) or (B)), it may be the same as the width w of the lip sliding portion 32 (FIG. 3(C)), and it may be larger than the width w of the lip sliding portion 32 (FIG. 3(D) or (E)).

Furthermore, when internal pressure (high pressure) of the bearing device is released through the gap 34, the role of the protrusion 33 comes to an end. Accordingly, if internal pressure does not rise again, the protrusion 33 may be a protrusion with a size that wears out after a predetermined operation time elapses (timed for when the initial test run and breaking in operation ends, and so on).

### DESCRIPTION OF REFERENCE NUMERALS

11 Sealing device
12 Metal ring
13 Rubbery elastic body
21 Seal lip (main lip)
31 Seal lip (grease lip)
31a Lip tip end portion
32 Lip sliding portion
33 Protrusion
33a End portion
34 Gap
51 Bearing device
52 Bearing outer ring
53 Bearing inner ring
A Bearing outer portion
B Bearing inner portion

1. A sealing device mounted in a vehicle bearing device, comprising:
a protrusion for forming a gap of part of the circumference between the seal lip and mating sliding member for adjusting the internal pressure of the bearing device, provided within the range of a sliding portion of the seal lip and on a portion of the circumference of the sliding portion, in a sealing device having a seal lip provided toward the inner portion of the bearing device.)

2. The sealing device according to claim 1, wherein the protrusion is provided as a protrusion positioned at a tip end portion of the seal lip.

3. The sealing device according to claim 1, wherein the protrusion is provided as a rib-shaped protrusion extending in a shaft direction.

4. The sealing device according to claim 1, wherein the protrusion is provided as a protrusion with a size that wears out after a predetermined operation time elapses.
